(19) United States
(12) Patent Application Publication
(10) Pub. No.: US 2009/0273950 A1
(43) Pub. Date: Nov. 5, 2009

(54) Power-saving device for power supply

(76) Inventor: Yun-Wen Peng, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/232,297

(22) Filed: Sep. 15, 2008

(30) Foreign Application Priority Data
May 2, 2008 (TW) 097207690

(51) Int. Cl. H02M 3/22; H02M 7/06

(52) U.S. Cl. 363/15; 363/126

(57) ABSTRACT

A power-saving device for power supply, including a transformer having a primary coil and a secondary coil. The primary coil is electrically connected with a power supply circuit of the power supply. The secondary coil is serially connected with a diode to electrically connect with a load via a load circuit. The power supply circuit controls powering on/off of the primary coil by means of a switch element. The load circuit includes a π-type filter circuit, which is chargeable and dischargeable. A power indicator circuit is forward parallel connected between the secondary coil of the transformer and the load circuit. The power indicator circuit includes a light-emitting diode. One terminal of the light-emitting diode is connected with P-pole of the diode. The diode acts as a barrier to the discharge of the π-type filter circuit so as to effectively reduce energy consumption of the power indicator circuit.

### BACKGROUND OF THE INVENTION

The present invention is related to a power-saving device for power supply, and more particularly to a power indicator circuit of a power supply, which is able to effectively reduce energy consumption and promote energy utility efficiency.

FIG. 1 is a circuit diagram of a conventional power supply. The conventional power supply includes a transformer 1, a power supply circuit 2 and a load circuit 3. A primary coil 11 of the transformer 1 is electrically connected with the power supply circuit 2. The power supply circuit 2 at least is composed of a rectifier/stabilizer unit 21, a central processing unit 22 and a switch element 23. The rectifier/stabilizer unit 21 is connected to an external AC power supply. The rectifier/stabilizer unit 21 serves to rectify the AC voltage into stable DC voltage. The switch element 23 is arranged between the primary coil 11 of the transformer 1 and the rectifier/stabilizer unit 21. The central processing unit 22 serves to control turning on/off of the switch element 23, whereby the primary coil 11 of the transformer 1 can be controllably connected with the rectifier/stabilizer unit 21. A secondary coil 12 of the transformer 1 is connected with the load circuit 3. The load circuit 3 includes a diode D3 forward connected with an output terminal of the secondary coil 12 of the transformer 1. The diode D3 is also connected with a π-type filter circuit 31, which is connected with a load. In addition, via a photocoupler transistor U2, the π-type filter circuit 31 can feed back a signal of output voltage to the central processing unit 22. For indicating the power output state of the power supply, a power indicator circuit 4 is parallel connected with two terminals of the secondary coil 12 of the transformer 1. The power indicator circuit 4 at least is composed of a resistor R13 and a light-emitting diode LED, which are connected in series. One terminal of the power indicator circuit 4 is electrically connected with N-pole of the diode D3. The light-emitting diode LED can emit light to indicate powering-on of the power supply.

When the switch element 23 is switched on, the primary coil 11 of the transformer 1 is powered to make the secondary coil 12 charge the π-type filter circuit 31. When the switch element 23 is switched off, the primary coil 11 of the transformer 1 is powered off and the π-type filter circuit 31 starts discharging. The light-emitting diode LED itself is an electric one-way valve. Therefore, the voltage across the power indicator circuit 4 keeps constant (12V as shown in FIG. 2). In this case, the power indicator circuit 4 will waste much power. This violates economic efficiency principle and environment protection requirements.

### SUMMARY OF THE INVENTION

It is therefore a primary object of the present invention to provide a power-saving device for power supply. In precondition that the manufacturing cost is not increased, the power-saving device is able to effectively reduce energy consumption and save use cost.

According to the above object, the power-saving device for power supply of the present invention includes a transformer having at least one primary coil and at least one secondary coil. The primary coil is electrically connectable with a power supply circuit of the power supply. The secondary coil is serially connectable with a diode to electrically connect with a load via a load circuit. The power-saving device further includes a power indicator circuit including a light-emitting diode forward parallel connected between the secondary coil of the transformer and the load circuit. One terminal of the light-emitting diode is connected with P-pole of the diode.

The present invention can be best understood through the following description and accompanying drawings wherein:

### BRIEF DESCRIPTION OF THE DRAWINGS

FIG. 1 is a circuit diagram of a conventional power supply;

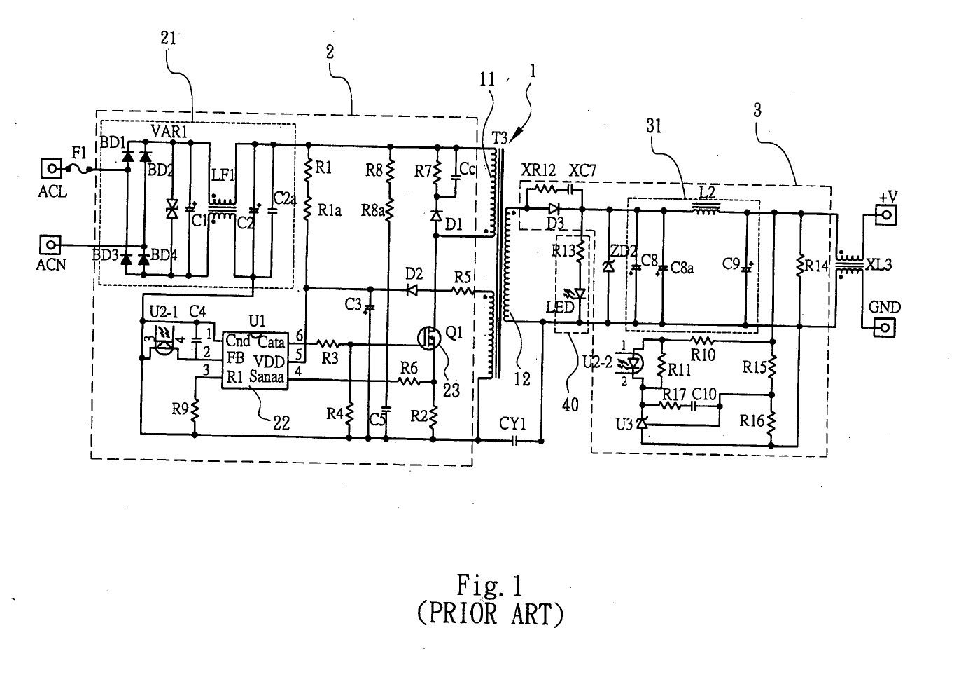

FIG. 2 is a waveform diagram of power loss of the power indicator circuit of the conventional power supply;

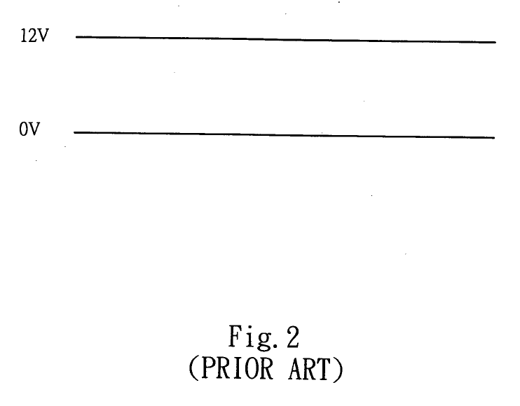

FIG. 3 is a circuit diagram of the power indicator circuit and power supply of the present invention;

FIG. 4 is a waveform diagram of power loss of the power indicator circuit of the present invention in full-load condition; and

FIG. 5 is a waveform diagram of power loss of the power indicator circuit of the present invention in no-load condition.

### DETAILED DESCRIPTION OF THE PREFERRED EMBODIMENTS

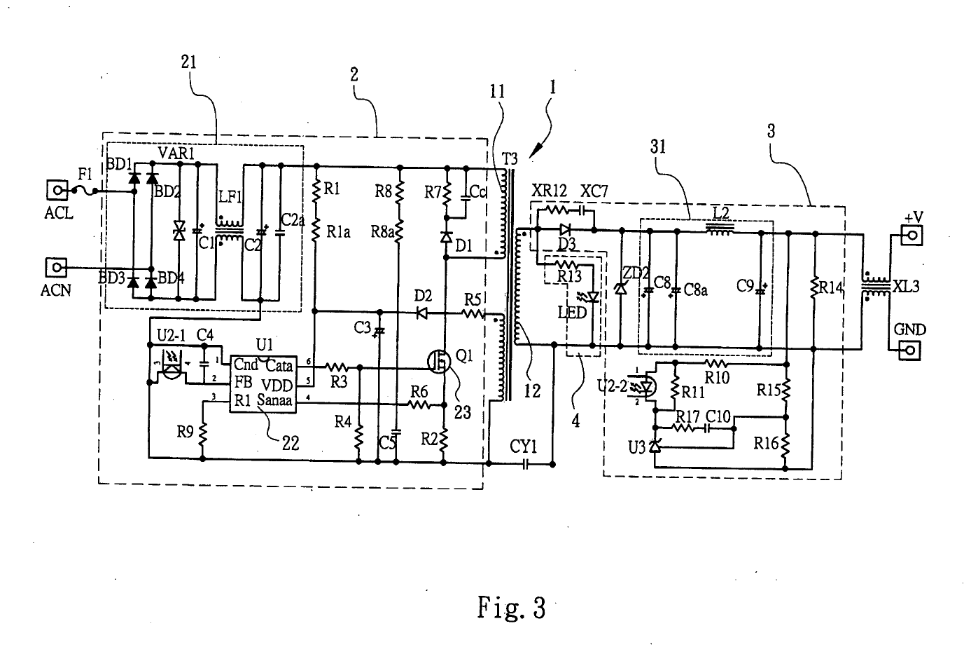

Please refer to FIGS. 3 to 5. The present invention includes a transformer 1, a power supply circuit 2, a load circuit 3 and a power indicator circuit 4. The power supply circuit 2 is electrically connected to a primary coil 11 of the transformer 1. The power supply circuit 2 at least is composed of a rectifier/stabilizer unit 21, a central processing unit 22 and a switch element 23. The rectifier/stabilizer unit 21 is connectable to an external AC power supply. The rectifier/stabilizer unit 21 serves to rectify the AC voltage into stable DC voltage and provide necessary power for internal components and external load. The central processing unit 22 serves to control turning on/off of the switch element 23, whereby the primary coil 11 of the transformer 1 can be controllably connected with the rectifier/stabilizer unit 21. The load circuit 3 includes a π-type filter circuit 31. An input terminal of the π-type filter circuit 31 is forward serially connected with a secondary coil 12 of the transformer 1 via a diode D3. An output terminal of the load circuit 3 is connectable with a load. In addition, via a photocoupler transistor U2, the π-type filter circuit 31 can feed back a signal of output voltage to the central processing unit 22. The power indicator circuit 4 at least is composed of a resistor R13 and a light-emitting diode LED, which are connected in series. The power indicator circuit 4 is forward parallel connected with two terminals of the secondary coil 12 of the transformer 1. (That is, one terminal of the power indicator circuit 4 is connected with the diode D3 and one terminal of the secondary coil 12, while the other terminal of the power indicator circuit 4 is connected with the other terminal of the secondary coil 12.)

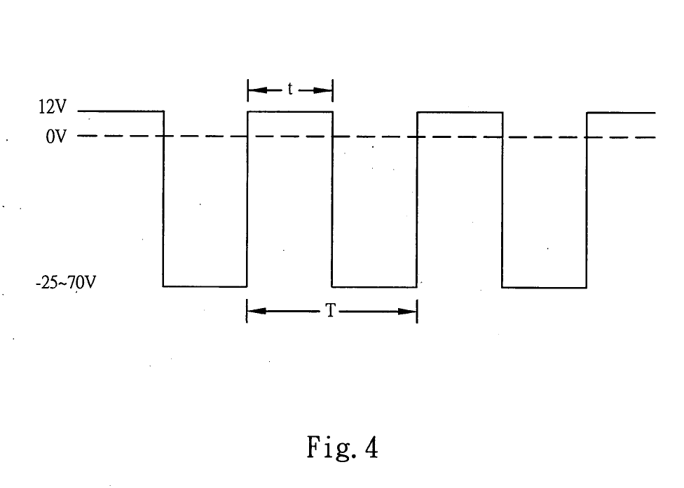

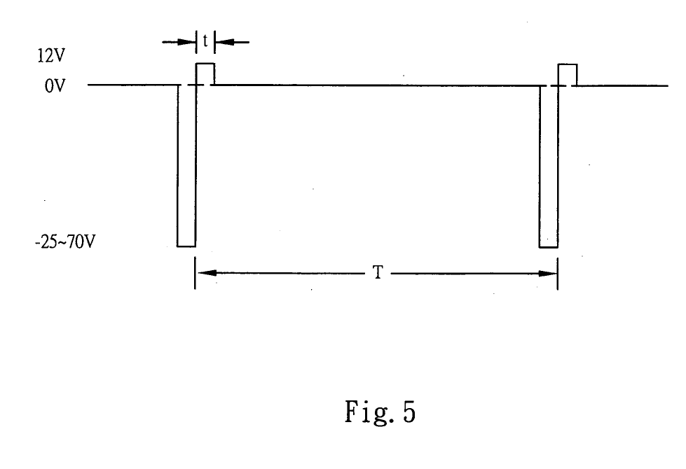

In practice, when the switch element 23 is controlled by the central processing unit 22 and switched on, the primary coil 11 of the transformer 1 is powered on to make the secondary coil 12 charge the π-type filter circuit 31. When the switch element 23 is switched off, the primary coil 11 of the transformer 1 is powered off and the π-type filter circuit 31 starts discharging. At this time, since the diode D3 is an electric one-way valve, the voltage across the power indicator circuit 4 is rectangular-wave voltage. Moreover, power loss will take place only in case of square wave of light-emitting diode LED. For example, when the power supply is in a full-load condition (about 2A as shown in FIG. 4), the working period t of the square wave is about 50% the full period T. Therefore, the power loss of the power indicator circuit 4 (light-emitting diode LED) is about ½ that of the conventional power supply. When the power supply is in a no-load condition (about 0A as shown in FIG. 5), the working period t of the square wave is about 5% the full period T. Therefore, the power loss of the power indicator circuit 4 (light-emitting diode LED) is about 1/20 that of the conventional power supply. Accordingly, the drop of power loss of the power indicator circuit 4 (light-emitting diode LED) ranges from 50% to 95%, depending on the load condition. This can effectively avoid unnecessary power loss so as to save energy and lower use cost.

The above embodiments are only used to illustrate the present invention, not intended to limit the scope thereof. Many modifications of the above embodiments can be made without departing from the spirit of the present invention.

What is claimed is:

1. A power-saving device for power supply, comprising:
a transformer including at least one primary coil and at least one secondary coil, the primary coil being electrically connectable with a power supply circuit of the power supply, the secondary coil being serially connectable with a diode to electrically connect with a load via a load circuit; and
a power indicator circuit including a light-emitting diode, the power indicator circuit being forward parallel connected between the secondary coil of the transformer and the load circuit, one terminal of the light-emitting diode being connected with P-pole of the diode.

2. The power-saving device for power supply as claimed in claim 1, wherein the light-emitting diode is at least serially connected with a resistor.

3. The power-saving device for power supply as claimed in claim 1, wherein the diode is parallel connected with a resistor and a capacitor, which are connected in series.

4. The power-saving device for power supply as claimed in claim 2, wherein the diode is parallel connected with a resistor and a capacitor, which are connected in series.

5. The power-saving device for power supply as claimed in claim 1, wherein the power supply circuit of the power supply includes a rectifier/stabilizer unit, a central processing unit and a switch element, the rectifier/stabilizer unit serving to convert external AC power into DC power, the central processing unit serving to control turning on/off of the switch element, whereby the primary coil of the transformer can supply rectangular-wave power.

6. The power-saving device for power supply as claimed in claim 2, wherein the power supply circuit of the power supply includes a rectifier/stabilizer unit, a central processing unit and a switch element, the rectifier/stabilizer unit serving to convert external AC power into DC power, the central processing unit serving to control turning on/off of the switch element, whereby the primary coil of the transformer can supply rectangular-wave power.

7. The power-saving device for power supply as claimed in claim 3, wherein the power supply circuit of the power supply includes a rectifier/stabilizer unit, a central processing unit and a switch element, the rectifier/stabilizer unit serving to convert external AC power into DC power, the central processing unit serving to control turning on/off of the switch element, whereby the primary coil of the transformer can supply rectangular-wave power.

8. The power-saving device for power supply as claimed in claim 4, wherein the power supply circuit of the power supply includes a rectifier/stabilizer unit, a central processing unit and a switch element, the rectifier/stabilizer unit serving to convert external AC power into DC power, the central processing unit serving to control turning on/off of the switch element, whereby the primary coil of the transformer can supply rectangular-wave power.

9. The power-saving device for power supply as claimed in claim 1, wherein a photocoupler transistor is arranged between the load circuit and the power supply circuit.

10. The power-saving device for power supply as claimed in claim 2, wherein a photocoupler transistor is arranged between the load circuit and the power supply circuit.

11. The power-saving device for power supply as claimed in claim 3, wherein a photocoupler transistor is arranged between the load circuit and the power supply circuit.

12. The power-saving device for power supply as claimed in claim 4, wherein a photocoupler transistor is arranged between the load circuit and the power supply circuit.

13. The power-saving device for power supply as claimed in claim 5, wherein a photocoupler transistor is arranged between the load circuit and the power supply circuit.

14. The power-saving device for power supply as claimed in claim 6, wherein a photocoupler transistor is arranged between the load circuit and the power supply circuit.

15. The power-saving device for power supply as claimed in claim 7, wherein a photocoupler transistor is arranged between the load circuit and the power supply circuit.

16. The power-saving device for power supply as claimed in claim 8, wherein a photocoupler transistor is arranged between the load circuit and the power supply circuit.
